(19) United States
(12) Patent Application Publication
(10) Pub. No.: US 2014/0346712 A1
(43) Pub. Date: Nov. 27, 2014

(54) CABLE WITH INJECTION MOLDED COUPLING PART

(71) Applicant: NEXANS, Paris (FR)

(72) Inventors: Otto Nachbauer, Floss (DE); Dietmar Voelkl, Ploessberg (DE); Thomas Noetzel, Floss (DE)

(21) Appl. No.: 14/295,643

(22) Filed: Jun. 4, 2014

Related U.S. Application Data
(62) Division of application No. 13/451,315, filed on Apr. 19, 2012.

(30) Foreign Application Priority Data
Jun. 29, 2011 (EP) 11305825.9

(51) Int. Cl. B29C 45/14

(52) U.S. Cl. CPC B29C 45/14467
USPC 264/494

(57) ABSTRACT

A method of making cable includes injection molding a coupling part which is manufactured from a polymer mixture with a thermoplastic material as polymer component, where the cable casing contains thermoplastic polyurethane cross-linked by radiation. The cable has a water-tight and fixed connection between the casing of the cable and the section of the coupling part injection molded around the casing.

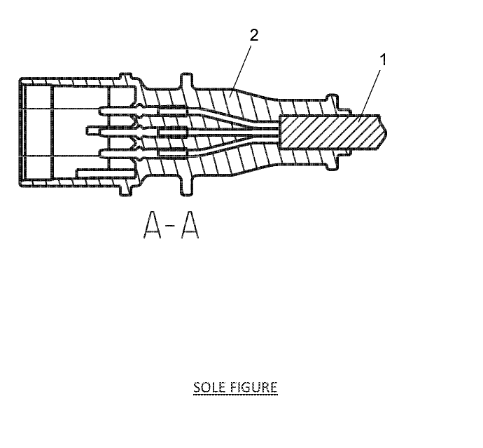

### RELATED APPLICATION

This application is a divisional application of U.S. patent application Ser. No. 13/451,315, filed on Apr. 19, 2012, which in turn claims the benefit of priority from European Patent Application No. 11 305 825.9, filed on Jun. 29, 2011, the entirety of which are incorporated by reference.

### BACKGROUND

1. Field of the Invention

The present invention relates to a coupling part for cables, and a coupling part according to the invention with a cable connected thereto, and a method for arranging or manufacturing the coupling part on the cable, or a method for manufacturing a coupling part with a cable connected thereto, wherein the cable has a high temperature-resistant casing. The cable preferably includes a casing of a polymer mixture whose polymer component contains or consists of thermoplastic polyurethane. Such a coupling part, also called plug, has for individual conductors of a connected cable a contact which is arranged in a recess or a bore of a contact carrier. The contacts arranged in recesses of the contact carrier which are separate from each other, are accessible from a contact side of the coupling part and are contacted by the conductors on the opposite connection side of the contact carrier. The conductors, including a section without casing, preferably including a cable section with casing, are surrounded by an injection molded coupling part which may be adjacent the connection side of the contact carrier, and/or may optionally surround the contact carrier over sections thereof or completely. The contact carrier may optionally be constructed in one piece with the injection molded coupling part and may be manufactured, for example, by injecting the substance which forms the injection molded coupling part section by section directly around contacts in an injection mold.

The coupling part according to the invention is characterized in that it forms a water-tight connection to the casing of the cable, at the end at which the cable enters into the coupling part.

2. Description of the Related Art

DE 3417811 C1 describes a method for mounting a coupling part in an electrical line in which a plug body of polyethylene, polyurethane, or polyvinyl chloride surrounds an end section of the cable casing.

DE 19754236 A1 describes a shrinking hose of PE or PP which is arranged for improving the appearance between a cable casing of PBC and an injection molded plug.

DE 10 2008 009 620 A1 describes that a cross-linked cable casing cannot be connected tightly with an injection molded synthetic substance and, therefore, provides for the arrangement of a shrinking hose over a section between the injection molded substance and the cable casing. The cable casing may be composed of polyolefin cross-linked by radiation or of chemically cross-linked polyolefin, for example, with silane.

DE 20 2006 012 240 U1 describes a plug connector for a cable which has an injection molded component. A water-tight connection can only be achieved by arranging an elastic cable bushing between the injection molded part and the cable casing.

EP 1 443 604 A1 describes the insulation of two flat conductor band lines which are connected to each other by means of a sealing material.

### OBJECT AND SUMMARY OF THE INVENTION

It is the object of the invention to make available a cable with a coupling part connected thereto, which rests in a moisture tight manner against the casing, in particular, forms an integral connection with the casing, wherein, in accordance with an especially preferred feature, the casing is temperature-resistant.

The invention meets this object with the features of the Claims, particularly with a cable which has an injection molded coupling part which is manufactured from a polymer mixture with a thermoplastic material as the polymer component and possibly organic and/or mineral fillers, wherein the cable is characterized in that the casing is composed of a polymer mixture whose polymer component contains or consists of thermoplastic polyurethane cross-linked by radiation, and preferably the casing of the cable is composed of thermoplastic polyurethane cross-linked by radiation, which, for example, essentially does not contain any mineral fillers. It has been found that a cable whose casing is composed of a polymer mixture according to the invention, whose polymer component contains or consists of thermoplastic polyurethane produces, when injecting a thermoplastic polymer mixture which forms the coupling part, a water-tight and fixed connection between the casing of the cable and the section of the coupling part injection molded around the casing. Similarly, the cable has an injection molded coupling part of a polymer mixture surrounding the casing, wherein the water-tight connection between casing and coupling part is formed by the direct contact between casing and coupling part, or consists of the integral connection of the coupling part with the casing. Since the water-tight connection between casing and coupling part is formed by the integral connection between casing and coupling part, this connection or the cable with the coupling part connected thereto does not have an additional sealing element, at least in the area of this connection, or preferably no additional sealing element overall.

The invention is also directed to the use of the cable with a coupling part injection molded onto the cable from a thermoplastic polymer mixture, wherein the cable has a casing of a polymer mixture whose polymer component contains or consists of thermoplastic polyurethane as a temperature-resistant connecting line, particularly as a connecting line for a temperature load of up to 200° C., particularly up to 220° C., for up to 30 minutes, preferably up to 1 hour, more preferred at least 1 hour, for example, 70 to 120 or up to 90 min., in particular as a water-tight moisture-tight, temperature-resistant connecting line.

Moreover, the invention relates to a method for manufacturing the cable according to the invention which method is distinguished by the manufacture of the coupling part by injection molding of a polymer mixture directly onto a circumferentially closed section of the casing, whose polymer component, which for example, contains or consists of thermoplastic polyurethane, polyamide, or polybutylene terephthalate, wherein the casing of the cable is composed of a polymer mixture whose polymer component contains or consists of thermoplastic polyurethane cross-linked by radiation. In accordance with the invention, an integrally connected, water-tight or moisture-tight and preferably temperature-resistant connection between the casing and the thermoplastic polyurethane produced by directly injecting the casing with the polymer mixture of the coupling part, which contains or consists of a thermoplastic polymer component.

In accordance with an especially preferred feature, the cable has one or more strands whose conductors are connected at the ends thereof to an electrically conducting contact piece, wherein the coupling part holds the contact pieces in recesses and is constructed as a single piece. In this embodiment, the cable with the coupling part at its one end is composed of a cable end section and the single piece coupling part which directly surrounds a section of the casing and is connected to the casing through a moisture-tight connection between the contact pieces arranged in recesses of the coupling part, wherein the contact pieces are at their ends arranged at the conductors of the cable.

The thermoplastic polymer mixture which forms the coupling part has or consists of one of the thermoplastic materials from the group which comprises or consists of polyamide, thermoplastic polyurethane, polybutylene terephthalate and mixtures thereof. Optionally, the polymer mixture of the coupling part may also contain organic aggregates, particularly anti-oxidation agents, anti-aging agents, and dyes, as well as mineral aggregates, in particular glass fibers, glass spheres.

The cable preferably has a casing of a polymer mixture, whose polymer component includes thermoplastic polyurethane cross-linked by radiation, or consists of thermoplastic polyurethane cross-linked by radiation. The thermoplastic polyurethane cross-linked by radiation preferably has the following properties: Temperature-resistance up to 220° C. for at least 1 hour, particularly for up to 10 cycles at a temperature of 220° C., preferably in combination with a permanent temperature-resistance of −40° C. to 150° C. for 3,000 h.

The temperature-resistance is measured using the following method: The cable is subjected to 10 cycles of horizontal, freely suspended or lying storage at 220° C. for 1 hour and to subsequent cooling to room temperature. Concerning the temperature-resistance, after the 10 cycles no deformation, no dripping and no melting of the casing was found, and preferably the casing has a sufficient resistance, particularly at least 75% to 90% of its original electrical and mechanical resistance.

The permanent temperature-resistance, preferably according to ISO 14572, is determined using the following method: After storage for 3,000 h at −40° C. to 150° C., the cable is wound up, unwound and the casing is optically examined. For the permanent temperature-resistance, the casing has no cracks and the cable passes the voltage test at 1 kV alternating current.

The cable according to the invention has a fixed connection, particularly an integrally formed water-tight connection, between casing and coupling part which is resistant especially against temperature variations, for example, resistant to temperature variations from 100 cycles, preferably 150 to 200 cycles of which each cycle includes or consists of heating to at least 80° C., preferably to 120° C. and cooling to 0° C. to 4° C. by placing in ice water. Such periodic temperature variations are also called ice water shock tests, for example, heating to 80° C. or 120° C., followed by cooling to 0° C. to 4° C. by placement into ice water for 100 cycles.

It has been found that the cable according to the invention has strength of the connection between casing and coupling part, before, as well as after, the ice water shock tests, which withstands a pressure test in which the connection is acted upon by compressed air of 0.5 or 1 bar on the side of the line or a partial side of the coupling. This withstanding at this internal pressure is indicated by a lack of bubble discharge for 30 s or 1 min from the cable arranged in the water bath.

### BRIEF DESCRIPTION OF THE DRAWINGS

The invention will now be described in more detail with reference to the FIGURE which shows schematically a cable according to the invention with a coupling part which was made by injection molding at the end thereof.

### DETAILED DESCRIPTION OF THE INVENTION

The FIGURE schematically shows a preferred embodiment of the cable according to the invention which includes a coupling part 2 manufactured by injection molding directly around an end section of the casing 1, which circumferentially surrounds section by section the casing 1 of the cable and, in accordance with the preferred embodiment is composed of one piece, and which holds contact pieces connected to the ends of the strands contained in the cable in recesses, so that the contact pieces are accessible through an axis opening for a counter piece of the coupling part.

In detail, the method for manufacturing the coupling part on a cable with a casing 1 of a polymer mixture on the basis of thermoplastic polyurethane cross-linked by radiation may include the following steps:
Making available a cable with a casing 1 composed of a polymer mixture which includes or consists of thermoplastic polyurethane cross-linked by radiation,
removing the insulation of at least one strand of the cable and contacting the conductor with a contact,
wherein especially the contact is arranged optionally in a recess of a contact carrier or alternatively, the contact carrier is formed as a single piece with the coupling part 2,
manufacturing a coupling part 2 by injection molding a polymer mixture around at least one section of the cable casing, whose polymer component contains or consists of a thermoplastic polymer, whereby the mixture is integrally connected to at least one circumferentially closed section of the casing 1,
optionally, injection molding of the polymer mixture forming the coupling part 2 can be carried out in such a way that the polymer mixture surrounds the contact carrier, preferably up to at most to the contact side of the contact carrier located on the opposite side of the connection side.

The cable had a permanent temperature-resistance for 3,000 h at 150° C. and a temperature-resistance for 10 cycles of up to at least 1 h at 200° C., or at 220° C.

A cable manufactured according to this method with a coupling part manufactured by injection molding was subjected to the ice water shock test with 100 to 200 cycles of heating to 80° C. or 120° C., each with cooling by immersion in water containing ice. The cable did not have any visible damage.

Subsequently, the cable was subjected to 0.5 or 1 bar compressed air from the side of the line and alternatively from the side of the coupling part, for example, by means of a bore in the cable interior or the interior of the coupling part adjacent to the connection between cable casing and coupling part, so that the adjacent excess pressure acted from the inside onto this connection. No air emerging from the connection was determined, for example, after immersion of the cable including the connection in water.

These results show that the coupling part with the required consistency forms a water-tight and pressure-tight connection with the temperature-resistant casing of the cable.

1. Method for manufacturing a cable, said method comprising the step of:
injection molding a coupling part by injecting an end section of the cable including its casing with a polymer mixture, whose polymer component includes a thermoplastic material selected from the group consisting of polyamide, thermoplastic polyurethane, polybutylene terephthalate and mixtures thereof,
wherein the cable includes a casing of a polymer mixture whose polymer component is composed of a thermoplastic polyurethane cross-linked by radiation, wherein a water-tight connection between the coupling part and the casing is produced by directly injecting a circumferentially closed casing section with the polymer mixture of the coupling part.

2. Method according to claim 1, wherein the casing has an aging resistance to at least 10 cycles at 220° C. for 1 h with cooling no room temperature and a permanent temperature-resistance to a storage for 3,000 h at a temperature of −40° C. to 150° C.

3. Method according to claim 1, wherein the water-tight connection of the casing relative to the coupling part has a resistance to an ice water shock test which is composed of at least 100 cycles of which each cycle includes heating to at least 80° C. and cooling to 0-4° C. by placement in ice water.

4. Method according to claim 1, wherein the water-tight connection of the casing to the coupling part has a resistance to a pressure application on the line side or on the coupling part side of at least 0.5 bar or at least 1 bar.
